(19) United States
(12) Patent Application Publication
(10) Pub. No.: US 2020/0356604 A1
(43) Pub. Date: Nov. 12, 2020

(54) QUESTION AND ANSWER SYSTEM AND ASSOCIATED METHOD

(71) Applicant: WATERFORD ENERGY SERVICES, INC., Halifax (CA)

(72) Inventor: Blair MACDOUGALL, Halifax (CA)

(73) Assignee: WATERFORD ENERGY SERVICES, INC., Halifax (CA)

(21) Appl. No.: 16/868,207

(22) Filed: May 6, 2020

Related U.S. Application Data
(60) Provisional application No. 62/843,803, filed on May 6, 2019.

(51) Int. Cl. G06F 16/9032; G06N 20/00; G06F 40/20; G06F 16/901

(52) U.S. Cl. CPC G06F 16/90332; G06F 16/9024; G06F 40/20; G06N 20/00

(57) ABSTRACT

An automated question and answer system is provided in which a user can pose questions and receive assistance from subject-matter experts. A database stores information useful in answering the questions, and an information retrieval component, for example including a natural language processing system, automatically retrieves potentially relevant content. A visual interface displays related questions and answers to the user, sorted by relevance. An adaptive component can adjust aspects of the information retrieval component, such as artificial intelligence or machine learning components, based on feedback from the user and subject-matter experts. The adaptive component can store information in the database which is derived from question-answer interactions, such as feedback indicative of similarity of the question to prior questions, relevance of answers, and user and subject-matter expert input.

### CROSS-REFERENCE TO RELATED APPLICATIONS

This application claims priority to U.S. Provisional Patent Application No. 62/843,803, entitled “Question and Answer System and Associated Method,” filed May 6, 2019, the entire contents of which are incorporated herein by reference.

### FIELD OF THE INVENTION

The present invention pertains to the field of computerized information systems and in particular to systems for sharing and accessing information on a subject.

### BACKGROUND

Quality of decision-making and project outcomes can be improved with access to relevant information. However, when the volume of available information is large, finding the most relevant information can be challenging. The challenge essentially is to obtain useful information out of records and unwritten expert knowledge. Interactive information retrieval systems aim to facilitate the information gathering process by providing a user with a set of appropriate tools to navigate large information sets. Expert systems aim to mimic the performance of an expert providing information and recommendations. Community question-and-answer forums are available through which a user can pose questions to other users or experts and receive advice.

Computer systems such as artificial intelligence systems and machine learning systems are being developed to tackle complex problems. These systems can often adapt to training data in order to become proficient in a certain task.

However, current information gathering systems such as question-and-answer systems rely heavily on the input of other users, and such systems to date have generally failed to incorporate aspects such as artificial intelligence and adaptive learning.

In industries with an aging work force, expert knowledge that was built up over many years of experience is at risk of being lost as senior workers retire. Means for effectively and efficiently capturing this expert knowledge would be valuable in such industries.

Therefore there is a need for a question and answer system that is not subject to one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of the present invention is to provide a question and answer system and associated method, in which the information stored by and inherent to the system grows over time due in part to capturing aspects of user interaction with the system, such as explicit and/or implicit feedback on result quality. Another object of the present invention is to provide a question and answer system which solicits and uses expert input in an effective manner.

In accordance with embodiments of the present invention, there is provided a computerized question and answer system, comprising: a user interface configured to accept input indicative of a user's question and to display output indicative of potential answers to the user's question; a database configured to store information to be drawn on for answering the user's question; an information retrieval component configured to automatically retrieve, from the database, potentially relevant content for display as said output, based on user input including the user's question. The user interface is further configured to obtain explicit or implicit feedback from the user, and the feedback is indicative of quality of one or more of the potential answers. The system further includes an adaptive component configured to adjust one or more operating parameters of the information retrieval component, one or more records stored in the database, or both, based on said feedback. It is noted that the user interface and the database can either be included in the system or excluded from the system. For example, the user interface and the database can be separate from the system but operatively coupled to the system. In either case, the adaptive component may be configured to receive explicit or implicit feedback from the user, where such feedback is indicative of quality of one or more of the potential answers.

In some embodiments, the information retrieval component comprises one or more machine learning or artificial intelligence components configured to automatically suggest answers or to automatically provide information usable in searching or obtaining answers, and the adaptive component is configured to update at least one of the one or more machine learning or artificial intelligence components based on said feedback. In further embodiments the one or more machine learning or artificial intelligence components comprises a natural language processing system.

In some embodiments, the adaptive component is configured to store, in the database, the user feedback, and/or the adaptive component is configured to process the user feedback and to store, in the database, output of processing of said user feedback. In some embodiments, the adaptive component will respond to future queries at least in part by performing searching or other processing on the stored user feedback and/or output of processing of user feedback. The user feedback can be used to guide processing of the query. In some cases the user feedback, or data generated based thereon, can be provided as part of a query response. Other user input, such as user-generated questions, subject-matter expert input, etc., can also be stored and future responses generated based at least in part on same.

In some embodiments, the information retrieval component is configured to provide, automatically based on the user's question, based on a subject-matter expert's response to the user's question, or both, previous questions which are stored in the database and deemed potentially similar to the user's question, and previous answers to the previous questions.

In some embodiments, the adaptive component is configured to store, in the database, the user's question along with the feedback, or along with an indication, based on the feedback, of user-influenced similarity between the user's question and one or more of the previous questions.

In various embodiments, the question and answer system relies on input from subject matter experts in order to answer questions or assist in answering questions. In some such embodiments, the system further comprises: a second user interface accessible by a subject matter expert different from the user, the second user interface configured to display the user's question and accept input from the subject-matter expert indicative of potential answers to the user's question or indicative of suggestions for adjusting the user's question. The second user interface is further configured to obtain explicit or implicit feedback from the subject matter expert, said feedback indicative of quality of one or more of the potential answers. The adaptive component is further configured to adjust one or more operating parameters of the information retrieval component, one or more records stored in the database, or both, based on said feedback. In some further embodiments, the adaptive component is further configured to adjust one or more operating parameters of the information retrieval component, one or more records stored in the database, or both, based on said input from the subject-matter expert indicative of potential answers to the user's question or indicative of suggestions for adjusting the user's question. It is noted that the second user interface can either be included in the system or excluded from the system. For example, the second user interface can be separate from the system but operatively coupled to the system. In either case, the adaptive component may be configured to receive additional explicit or implicit feedback obtained from a subject matter expert, where the additional feedback is indicative of quality of one or more of the potential answers, and the additional feedback is obtained after the subject matter expert interacts with the user's question.

Other aspects of the present invention provide for a method for performing system operations as discussed above and elsewhere herein, or a computer program product comprising instructions which when operated by a computer cause such a method to be performed.

### BRIEF DESCRIPTION OF THE FIGURES

Further features and advantages of the present invention will become apparent from the following detailed description, taken in combination with the appended drawings, in which:

FIG. 1 illustrates a question-and-answer process provided in accordance with an embodiment of the present invention.

FIG. 2 illustrates a visual interface for the question-and-answer system, according to an embodiment of the present invention.

FIG. 3 illustrates four relevance maps corresponding to four query scenarios.

FIG. 4 illustrates a pop-up that can appear in the visual interface.

FIG. 5 is a block diagram of a system provided according to an embodiment of the present invention.

FIG. 6 is another block diagram of a system provided according to an embodiment of the present invention.

FIG. 7 illustrates interactions between components of FIG. 6, according to embodiments of the present invention.

It will be noted that throughout the appended drawings, like features are identified by like reference numerals.

### DETAILED DESCRIPTION

Unless defined otherwise, all technical and scientific terms used herein have the same meaning as commonly understood by one of ordinary skill in the art to which this invention belongs.

Embodiments of the present invention provide for a mentored question and answer system. The system may be configured to access enterprise data such as historical data related to a company, projects, or series of projects. The system may be configured to receive input from regular users (e.g. posing questions and providing feedback) as well as from subject matter experts (SMEs). Mentorship may be provided by allowing one or more SMEs to access the system in order to provide input related to answering posed questions. In some embodiments, the subject matter experts are pre-approved, for example according to a company management process. In some embodiments, additional stakeholders, such as but not necessarily limited to regulators, contractors and vendors, can also be provided with access to the system. Such additional stakeholders may act in the capacity of a subject matter expert, a user with questions, or both.

In some embodiments, the method and system may incorporate a management approval process for relatively or deemed high risk decisions. For example, when a regular user or subject matter expert interacts with a question that they deem is high risk, the question can be flagged as such and queued for review by an appropriate organizational decision maker.

According to various embodiments, the question and answer system is configured to store questions and answers that are generated in an ongoing manner due to usage of the system. These questions and answers may be provided as part of feedback provided to the question and answer system. The questions and answers may be stored in a database or other computerized logical structure. The question and answer system is further configured, upon receipt of a new question, to search the stored questions and answers for prior questions that are similar to the new question, and answers that are potentially relevant to the new question. The search may be performed automatically by computer processes. The potentially relevant answers may be answers to the prior questions that are similar to the new question. The question and answer system is configured to return, as a result of the search, one or more of the prior questions and/or potentially relevant answers. The results may then be reviewed and refined by subject matter experts and/or regular users.

User feedback indicative of the quality or relevance of question and answers may be obtained and stored along with such questions and answers, for example as metadata. Feedback may be obtained from users (posing question), SMEs, or both. Feedback may be automatically solicited during certain points of the question and answer interaction. Feedback may be implicit in some cases, for example due to user interactions with presented material. Users and SMEs can indicate relevance or usefulness and the indication may be provided as part of the feedback. The indication may be provided in the form of a score or ranking for example. Questions and answers which have historically been indicated as higher quality may be returned with higher precedence than questions and answers historically associated with lower quality. This may include, for example, returning only those prior questions and answers which have at least a threshold level of quality, and/or ordering the returned results at least partially according to quality. User feedback, or the output of processing of user feedback according to a given processing routine, can thus be stored in the database. Once stored, the material can be interacted with by the information retrieval component when processing future queries. The feedback can be linked to the user's question in the database, for example by providing or characterizing a link in the database between question and feedback entries.

An example of implicit user feedback is as follows. When a user receives a response to a query, the user may either stop using the system without interacting with the results, revise and re-submit the query, or interact with the query results to varying degrees. Stopping use of the system without interacting with the results may be interpreted as feedback indicative that the query response is not satisfactory (although other reasons for this behaviour are also possible). Revising and re-submitting the query may also be interpreted as feedback indicative that the initial query response is not satisfactory. However, the revised query, if satisfactory, may suggest an alternative query phrasing that can be stored by the system for example as suggested alternative language. When a future, similar query is run, the more successful suggested alternative language can be presented. Interacting with the results may be interpreted as feedback indicative that the query response is satisfactory, and the degree to which the user interacts with the results (e.g. measured based on the time spent, the number of results reviewed, etc.) can be used as a measure of how satisfactory the query response is. The degree can be measured for example as a function of the amount of time the user spends interacting with the response, the number of actions the user takes while interacting response, or the like, or a combination thereof. In general, aspects of the user's interaction with the query results (including a lack of such interaction) can be monitored and interpreted as feedback, and the system can be adjusted based on such feedback. Such aspects can include the extent to which the user interacts with the query results, and the type of user interaction with the query results. Adjustment to the system based on user feedback can be performed by an adaptive component of the system. There are a variety of user or subject matter expert interactions with the system or with each other, for example as described herein. Each of these can be used as feedback based upon which the system, database, or both, can be adjusted.

Quality may include but is not necessarily limited to objective score levels. Quality may be contextual to the question language and the information returned as a result. For example, quality may be an indication of correlation between a first keyword or phrase found in a current question, and a second keyword of phrase found in a prior question or associated answer. The correlation may be stored and may be strengthened when a user, after entering a current question, performs actions indicating interest in or relevance of the prior question or its associated answer, and weakened otherwise.

The obtained feedback may generally be used, for example by an adaptive component, to train or configure certain aspects of the question and answer system. For example, the feedback may be provided as metadata or additional database fields, the feedback being associated with related questions and answers. As another example, operating parameters, such as computer processing routines can be adapted based at least in part on the obtained feedback. The computer processing routines can include as artificial intelligence (AI) or machine learning routines.

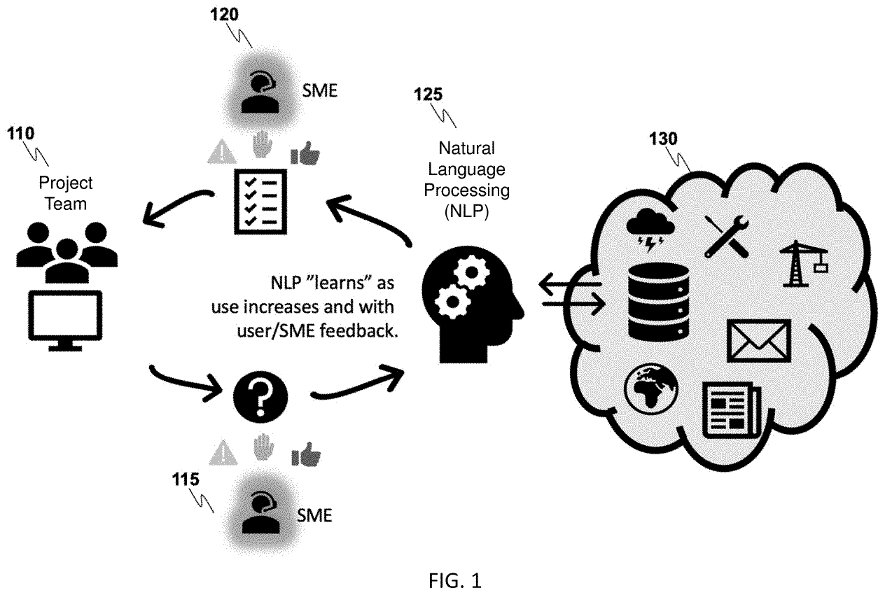

FIG. 1 illustrates a question-and-answer process provided in accordance with an embodiment of the present invention. A project team 110 may pose questions and receive answers from one or more subject matter experts 115, 120, through interaction with the question and answer system. The subject matter experts can answer questions directly or can assist or advise in interacting with a knowledge database 130. The answers or assistance can also be recorded in the knowledge database, used as feedback to adjust the system, or both. The subject matter experts can also generate feedback such as information indicative of question and/or answer quality. For example, the SMEs can rank questions and answers according to usefulness or relevance. The subject matter experts can also generate input such as indications of high risk situations requiring management approval, indication of risk levels associated with actions based on which the questions are being asked, or the like. In some embodiments, the project team can interact directly with the knowledge database 130. In other embodiments, the project team (regular users) only interacts with the knowledge database indirectly via the subject matter experts.

Subject matter experts may use a different user interface than regular users. The feedback provided by the subject-matter experts can be used, for example by the adaptive system component, to adjust system operating parameters, in much the same way as the feedback from other users is used, as described herein. The feedback from subject matter experts can be explicit or implicit. Explicit feedback can include ratings, question answers, question responses or clarifying questions, etc. Implicit feedback can include for example the degree to which the expert interacts with the question, the degree to which the expert interacts with the system or other resources to answer the question, etc. Implicit feedback can involve multiple parties. For example, the degree to which a user and an expert interact to answer a question may be implicit feedback as to the importance of the question. The number of users and experts who interact, and aspects of such interaction, can also be used as implicit feedback.

It is not always necessary to know in detail what implicit feedback represents or how it is useful. Rather, in some cases, available feedback can be provided to a machine learning or artificial intelligence component which may configure its behaviour based on the feedback without necessary regard to the knowledge of what the implicit feedback represents, how it is useful, or both.

The knowledge database can include a variety of information, such as enterprise data, geographic and weather data, commodity and service pricing data, public articles, and the like. The enterprise data may include privately held information such as emails, various business documents and analysis data, reports, manuals, internal websites, operations data, equipment history and repair records, and the like. The knowledge database can further include prior questions and answers to such questions recorded in response to prior interactions with the present system. The knowledge database can further be updated to incorporate any potentially relevant information generated due to usage of the system. The updating can be performed by an adaptive component of the system. Such information can be stored as new database entries or fields related to existing database entries. Some such fields may be metadata which describes characteristics of a main knowledge item. Essentially any type of recorded information that can be used as a resource for answering potential questions can be included in the knowledge database. Interactions with the system may additionally or alternatively be used to adjust processing routines of the system. For example, information indicative of interactions may be fed as input to artificial intelligence or machine learning routines. Feedback from the user can be provided, in a processed or unprocessed manner, to machine learning or artificial intelligence components, and used as training data, to train and thus adjust such machine learning or artificial intelligence components. Such training may be based on known adaptive machine learning techniques. Such training is an example of adjusting operating parameters of the system, for example the information retrieval component thereof.

A natural language processing (NLP) system 125 is also provided. Users such as subject matter experts 115, 120 and users entering queries may interact with the knowledge database 130 by using the natural language processing system 125. Additionally or alternatively, the natural language processing system 125 may monitor interactions with the knowledge database 130. The natural language processing system learns or adapts over time in response to interaction the natural language processing system itself, and/or interaction with entities such as the knowledge database where such interactions are monitored or periodically reviewed by the natural language processing system. The natural language processing system further learns or adapts over time in response to feedback from users and/or SMEs. Such feedback may include but is not necessarily limited to indications of quality of question answers. The NLP system is thus an instance of a machine learning or artificial intelligence component which may be adjusted based on user feedback.

In various embodiments, at least some of the content of the knowledge database is unstructured data. The system, for example the NLP system, may be configured to process the unstructured data to determine contents applicable to a current question. Processing can occur on an as-needed basis or prior to need. The unstructured data may refer to data that is not organized in a pre-defined manner, and may include articles, emails, memos, etc. The unstructured data may be contrasted with data stored in fielded or annotated forms, and may be contrasted with relational data. For clarity, it is noted that, while the database itself may be relational or structured in nature, the unstructured data may be contained within fields of the database. Alternatively the unstructured data may be stored elsewhere, and fields of the database may contain pointers or links to the unstructured data. Queries may be performed on the structured data, and further on the unstructured data which is contained within, pointed to, or otherwise associated with the structured data. Natural language processing is particularly relevant for processing unstructured data to return potentially relevant answers to user questions.

Because knowledge is accumulated over time by storing questions and answers (and related material) in an ongoing manner, the database is maintained without or with limited separate effort. The database may store user input related to queries and answers to queries, as well as feedback and automatically generated information for example due to natural language processing performed on queries or query results. All of this data is accumulated over time and can be searched and provided, where relevant, in responses to future queries. Database records can be adjusted based on feedback, for example by storing the feedback as database records, adjusting the links between database records based on the feedback, or a combination thereof.

According to various embodiments, the question and answer system comprises a visual interface, such as a graphical user interface, which is configured to facilitate a user's exploratory search of stored questions and answers. The interface can show an abstract view and a detailed view of the output, and be configured in various ways which facilitate the user's interaction with stored information. For example, the interface may incorporate lists, word clouds, dynamically generated windows showing information, statistics or ratings, timestamps, bolded keywords, colour-coded texts, variable font size indicative of texts of differing importance, or the like, or a combination thereof.

Various components of the visual interface can be synchronized and updated in response to user actions. This allows the user to track the effects of their interactions with the system. A relevance map and word cloud can show the overall distribution as an abstract representation of the documents, while a Sankey diagram, also known as a Sankey graph, can represent a more detailed representation and provide a focal point for collection of feedback. A ranking chart can provide an overview of the ranking of top results in relation to the user's query.

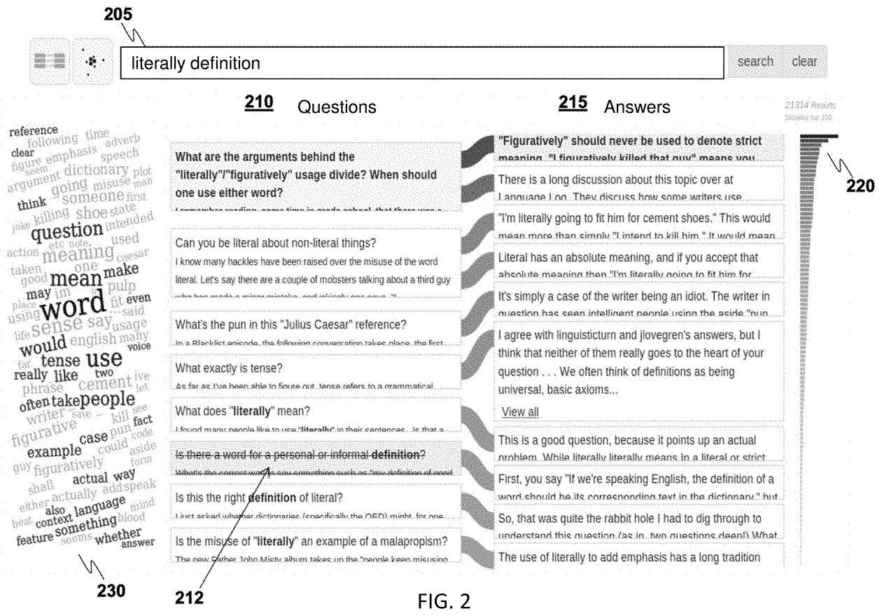

FIG. 2 illustrates a visual interface for the question-and-answer system, according to an embodiment of the present invention. The illustration is an example only and can be varied in many ways. A search bar 205 is provided in which a user can enter keywords or a question. In response to such an entry, a set of potentially relevant prior questions 210 and a set of associated prior answers 215 are displayed. The questions and answers can be ranked from top to bottom by relevance, and a ranking chart (also referred to as a relevance index) 220 showing a calculated relevance for the ranked questions and answers can also be displayed. In some embodiments, a set of users and SMEs and their status (e.g. online or offline) can also be shown for example in a chat window. This allows questions and discussions to be potentially performed interactively and in real time. A word cloud 230 can be shown indicating keywords that are relevant to the search, as well as to the associated questions and answers. Prominence of words in the word cloud can be indicated by size, color and/or shading. Words may be made more prominent when they appear more often and/or in more relevant questions and answers. The word cloud may be adjusted as the user interacts with the system. For example, when a user or SME flags a question or answer as more relevant or less relevant, the word cloud can be updated. As another example, when a user selects a certain question or answer for further analysis, the word cloud can be updated to highlight those words that are most relevant in that certain question or answer. In order to ease the reading of words for the user, a maximum rotation can be applied to the words, such as 15 degrees.

In some embodiments, to interact with the system, a user or SME can flag related prior questions as more relevant or less relevant. For example in FIG. 2 prior question 212 has been flagged as not relevant, indicated by strikethrough text. Such an action can be used as feedback based upon which components or operating parameters of the system can learn or adapt, for example by action of the adaptive system. For example, the NLP system 125 can update its word associations to reduce the correlation between the particular search query that was entered and this particular type of prior question.

According to FIG. 2, relationships between displayed questions and answers can be associated using a Sankey diagram. Nodes of the Sankey diagram contain the initial characters of questions and answers as snippets, arrows connecting the questions to their associated answers are shown, and the widths of the arrows can illustrate metrics such as the strength of the association between questions and answers. Answer nodes have the same height such as to fill a designated area on the screen, while question node heights can be calculated dynamically to fit all the related questions to the top retrieved answers. Once the query changes or feedback is provided, such as by clicking, double-clicking or triple-clicking on a node, the nodes can be rearranged to display the new results.

Further, when the user scrolls over a node of the Sankey graph, it can expand and reveals a link allowing the user to view the remaining text in a pop-up. The pop-up can contain an entire thread associated with a question. In some embodiments, scrolling over a node can also highlight respective words in a connected word cloud, while other words of the word cloud fade in color.

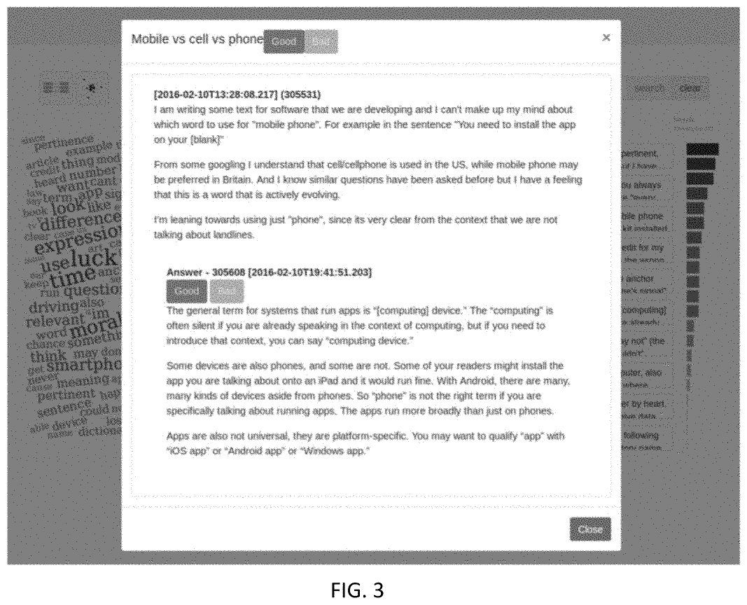

FIG. 3 illustrates a pop-up containing a question and an answer, that can appear when a user selects a node from the Sankey graph.

A relevance map indicative of relevance of the returned results can be implemented and configured using various approaches for example as described in “Visual re-ranking for multi-aspect information retrieval,” Klouche et al., in Proceedings of the 2017 Conference on Human Information Interaction and Retrieval, ACM; 2017, pp. 57-66 [Klouche]. The relevance r_{qid}_{ⱼ} of a document to a given query can be calculated based on the occurrence of terms in the document and the probability of the query term occurring in the corpus of the document, using the following function:

$${r}_{{qid}_{j}} = \frac{c ( {q}_{i} \vert {d}_{j} ) + μ p ( {q}_{i} \vert C )}{{\sum }_{k} c ( q \vert {d}_{j} ) + μ}$$

where:

qᵢ is a query term,

dⱼ is a document,

c(qᵢ|dᵢ) is the occurrence of query term qᵢ in document dⱼ,

p(qᵢ|C) is the probability (proportion) of query term qᵢ occurring in the corpus of

the document, considering the occurrence of all query terms, and

μ is a parameter as used in Klouche.

In some embodiments, a relevance map can be displayed on the visual interface wherein dots representing documents are scattered around a dot representing a query term or between many of dots representing a plurality of query terms. If there is one query term, each dot is circularly scattered such that its radial distance d to the query term dot is calculated with:

d=1-r_{qid}_{ⱼ}

and its direction is randomly selected. If there are more than one query terms, each one is assigned a position on the relevance map, and each document dot is placed between the term positions by averaging the position of the query terms multiplied by the relevancy r_{qid}_{ⱼ} of the document against each query term.

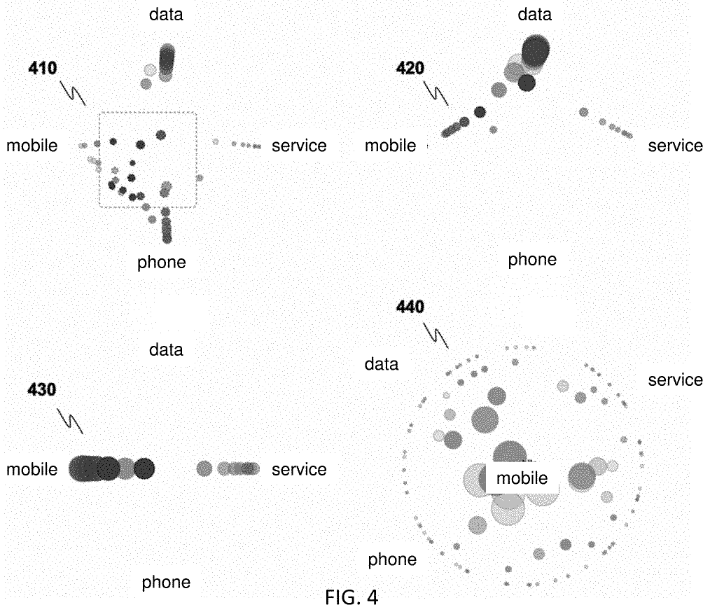

FIG. 4 illustrates four relevance maps created with the above method. Case (a) 410 corresponds to a query using 4 active terms, case (b) 420 to a query of 3 active terms, and case (c) 430 to a query of 2 active terms. Case (d) 440 corresponds to the simplest case of a single active term. It shows scattering along a random angle and radial distances calculated from

d=1-r_{qid}_{ⱼ}.

In some embodiments, the user may be able to interactively change the query by dragging and dropping query terms into different positions, or enabling or disabling query terms. Such actions can result in a corresponding adjustment of the query results.

Performance of the system can be evaluated by measuring the proportion of useful information returned in response to a question. This corresponds to the precision of the response. Performance can also be evaluated by measuring the proportion of useful answers returned relative to the total number of possible useful answers. This corresponds to the completeness of the response. Feedback by users and SMEs, indicative of usefulness of answers, can be used by the system as input to a performance evaluation routine. User feedback can involve selecting or clicking on certain displayed content, providing an input such as a numerical or three-way (yes, no, neutral) input indicative of relevance, or the like.

In various embodiments, displayed results can be re-ranked in real time based on the user feedback. For example, potentially relevant questions, which are initially deemed similar to the currently posed question, but that are marked by the user as less relevant, will have their related answers also marked as less relevant when input into machine learning routines as training data. For example, the question and the answers (with marked relevance) can be input as training data into a machine learning routine which drives the NLP processing. Likewise, potentially relevant similar questions that are marked by the user as more relevant will have their related answers also marked as more relevant when input into machine learning algorithms as training data. A similarity which is marked by the user as more or less relevant is referred to as user-influenced similarity.

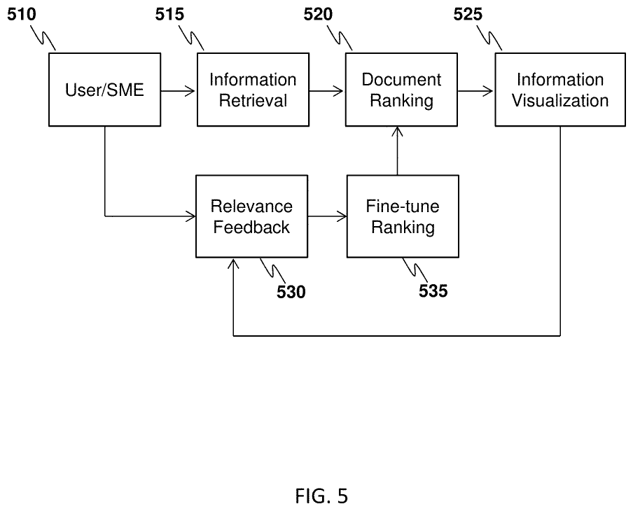

FIG. 5 illustrates a system provided according to an embodiment of the present invention. The system may be generally described as an interactive information retrieval system with relevance feedback. A user 510 interacting with the system is shown. The system includes an information retrieval component 515, a document ranking component 520, and information visualization component 525, a relevance feedback component 530, and a fine-tune ranking component 535. The system may further include other components such as a database and a natural language processing system.

In various embodiments, given a user query, the system retrieves documents such as questions and answers using the information retrieval component 515, ranks the documents using the document ranking component 520, and displays them to the user using the information visualization component 525. The user provides feedback to the system using the relevance feedback component 530. This feedback can be used to refine the displayed results, as well as to adjust future operation or operating parameters of the system. The process of user query and feedback can repeat with iteratively revised queries, until the user is satisfied with the list of retrieved documents or provided answer.

The information retrieval component 515 may use natural language processing to parse the query database contents, in order to search for return relevant content. In some embodiments, the information retrieval component can be based on a model such as the TF-IDF model as described in “Introduction to modern information retrieval,” G. Salton and M J McGill, 1986. To fine tune the ranking of return results, other algorithms such as the LambdaMART Learning to Rank (LtR) algorithm described in “Adapting boosting for information retrieval measures,” Q. Wu et al., Information Retrieval, 2010; 13(3): 254-270 can be employed.

Accordingly, the information retrieval component retrieves potentially relevant content from a database, based on an input user query. The content can be in the form of a potential answer to a user question, for example. As described herein, the information retrieval component can include machine learning or artificial intelligence system components, such as NLP system components. Information is retrieved automatically by such system components, by interacting with the database. The manner of interaction may be adjusted over time by the adaptive system component.

The information retrieval component does not necessarily (or does not necessarily solely) return results to a user query as a first action. In some cases, the information retrieval component can pose clarifying questions in one more steps, or prompt the user for further input. Thus, a guided multi-step query can be performed. The clarifying questions or prompts can be generated by a machine learning or artificial intelligence system component, for example.

In some embodiments, feature vectors considering both the query and the document must be generated to train a LambdaMART model, and the features can include any combination of: raw query length, normalized query length, raw document length, normalized document length, normalized frequency of query term, normalized frequency of document, and the term frequency-inverse document frequency (TF-IDF) index of document terms based on the words in the entire document corpus. The features can be included as a way for the model to learn the relatedness of various terms to the user query, and the retrieved answer and documents can be displayed to the user though the information visualization component.

In some embodiment, documents having received feedback can be used for fine-tuning a pre-trained LtR model. The results can then be re-ranked accordingly, and the process can continue until the user is satisfied with the results. Feedback can be handled differently for questions and documents. Positive feedback can have a value of 2, and negative feedback can have a value of 0.

According to some embodiments, operation of the system proceeds according to the following process. It should be noted that this process can be varied in many ways while remaining within the scope of the present invention.

First, the user asks a question from the system, in the form of an entered query. If there is any incorrect spelling or grammar in the question, it may be automatically corrected. The history of the questions is kept for future reference. If the question is not complete or is vague, one or more suggestions may be presented to the user to improve the specificity of their question. Next, the topic of the question is determined, and similar topics are presented to the user in a graphical visualization. Any specification or relevant information that is missing in the query may be determined and a suggestion to the user may be made to include one or more additional terms, such as topics or keywords, or date and location information, or contextual information such as weather or equipment information. Named entity recognition techniques can be used for this purpose.

In some embodiments, incompleteness or vagueness of a question may be determined by using natural language processing metrics, or evaluating the results returned by the system in response to a question, or a combination thereof. For example, if the results returned to a question are dissimilar according to a given metric, which may be based on natural language processing or on associated structured data, the question can be characterized as insufficiently precise (i.e. vague).

Following the above, a determination is made as to whether the question has already been asked, and if so whether there is a verified answer (e.g. verified by an SME) for it. If so, the answer will be fetched from the database. The user may verify whether or not the SME's responses have been helpful. To retrieve relevant already-asked questions, a search for questions with highest similarity to the current question is performed. This may involve indexing the questions according to a representation vector. The vector represents text in a numeric vector form according to a predetermined mapping rule.

The user can provide feedback on one or more produced answers based for example on the result they achieve by applying that solution. The user can request to reopen a question if the current solution does not meet their requirements. In doing so, they may be prompted to add a comment explaining their situation and the result obtained from applying the existing suggested solution. In some embodiments the user may be required to add such a comment before being given access (or adequate access) to answers. The question may be sent to the SME who provided the solution, or another SME. The question may be marked with higher priority in this case.

If there is no existing question stored in the system which matches the current question, one or more of the most similar question will be shown to the user. A high recall information retrieval algorithm may be used to determine previous questions that are most similar to the current question. Similarity may be determined based on numerical analysis of the vectors representing the documents associated with previous questions and/or their answers. A learning to rank algorithm may be applied on top of the returned list to sort the documents based on factors such as similarity of documents. The similar questions may be sorted by factors such as having a verified answer, and the cumulate amount of positive feedback (e.g. number of votes) from users and SMEs. This list of similar questions may be sorted in a way that the most similar documents appear closer to the top of the list. For each question, the list of its topics and specifications may be shown to the user. The user can select any of these questions and re-start the process in order to obtain a relevant answer to their now-modified question. In some embodiments, the user can change the sensitivity of search keywords to alter the question and answer quality.

If the question (or a closely similar question) has not previously been stored in the system, or if there is no verified answer for the question, the most similar documents related to the question will be shown to the user. This list of documents may be sorted such that the most similar documents appear closer to the top of the list. The user can provide feedback on the presented documents to indicate their suitability (or lack thereof) for answering the question. For each document, the list of its topics and specifications may be shown to the user. The feedback is used by the system to improve the ranking of the documents, for example as input to artificial intelligence or machine learning processes which retrieve documents, similar questions, and related answers in response to queries. In some embodiments, the user can comment on the documents and suggest documents as potential solutions for the question. This information may then be sent to SMEs along with the question for evaluation.

In some embodiments, the user can decide to send the question to a specific SME, or to multiple or all SMEs for soliciting their feedback and solution to the problem. In this case the question may be saved as high priority in the list of tasks for the SME(s). A list of SMEs may be provided, sorted according to the relevance of their skills to the question. The SMEs may be listed and sorted automatically in a similar manner to how documents or answers are retrieved and sorted. Each SME may be associated with a list of skills, which may be displayed as part of a profile to help the user select the most expert SME for their question. In some embodiments, the user can select not to send the question to SMEs. In this case, the question will be saved in the database as low priority for answering by SMEs. The question may be saved into SMEs tasks for their response.

Interaction between a user and an SME, or between users or SMEs, can be facilitated by the system. This allows for a single point of contact for obtaining both automatically generated and manually generated answers to questions. Furthermore, this allows for the interactions to be monitored and stored, either in raw or processed form, in the database as structured and/or unstructured data, with future queries being run on the database. Accordingly, the interactions provide for a rich source of content upon which the system can operate, for example to adapt to queries and/or to answer future queries.

Aspects of the SME interface will now be described. The system may provide each subject-matter expert (SME) with a list of question asked which designate that SME or which designate all SMEs. SME can search among the list of questions to find a specific one. SMEs can filter the questions based on their state, such as open, closed, or urgent state. SMEs can filter the questions based on their priority such as high or low.

For each question, the system may display a current state, priority, text, creation date, updated date, number of answers, and a list of actions that are available. A list of questions may be presented in a manner which is sortable by one or more of the above factors in ascending or descending order. SME can select a displayed question for further action. Upon selection, all the text of the question may be shown to the SME in a new page. A list of topics, specifications, creator, date and state of the query along with its history may be made available for SME. The system may accept SME input such as comments to the question and suggestions for a better question.

The SME can be provided with the automatically generated list of documents which have been deemed suitable by the system for solving this question, for example based on similarity metrics as described above. The list may include the documents that are like the query in terms of the context, topics, and specifications. The list may be sorted in a way that the more similar documents are placed in higher rank. In this ranking the existence of other SMEs feedback is also considered.

In some embodiments, each SME can see feedback from other SMEs for each document, along with their topics and specifications. SMEs can provide feedback indicative of relevance of a document to the question, and select it and send it to the user as a potential solution. SMEs can add feedback to a document to complete its context or their answer to the user's question. SMEs can edit topics and specifications related to each document. SMEs can open details of the document in a new window. SME can be presented with a list of the suggested answers by the users for the question. SMEs can perform other tasks that regular users can perform. SMEs can accept or reject the suggestions of regular users or other SMEs by adding comments. These comments may be sent to the user posing the question, for their reference. SME can create their own answer to a query. SME can search among existing documents (e.g. automatically returned by the system or stored in the database) to select one or more which are relevant for solving the question. SME can add free text which fully or partially answers the question, or which directs further searching. SME can select multiple sources of information and add extra text to connect them together or complete the answer to the question. SME can add topics and specifications for the answer that they generate for this question.

The system provides a dashboard for users and SMEs to monitor their interactions with the system and display a history of their activities. According to some embodiments, the dashboard provides some or all of the following features. Regular users can see a list of their questions along with their status, and notifications. A user can add comment to their own questions, verify the solution and provide feedback (e.g. vote) on the answers provided for their question. The user can select a question to see a full list of answers to that question and all the information on each question. The user can combine multiple answers which solve his problem and suggest it as a solution for the question to the SMEs. This list can be sorted by all the mentioned factors in the table.

SMEs can see a list of the answers that they provided for the users. This list contains the question, SME answer(s) and other answers to this specific question along with the user's votes on their answer. The list can include one or more similar, previously posed questions retrieved from the database. SME can select each answer to view more detailed information for the associated question. SME can open a question for editing.

In some embodiments, users and/or SMEs have a record of their feedback previously provided the system, and may have an option to modify the feedback. Modification of feedback may trigger updating of database contents and/or the modified feedback may be provided as input to artificial intelligence and machine learning processes. This record includes the questions, their answers, comments, and user's votes on the question and answers. The users and SMEs may modify their comments if the status of the question and answer is still open. The users and SMEs may modify their feedback indicative of answer relevance if the status if the question and answer is still open.

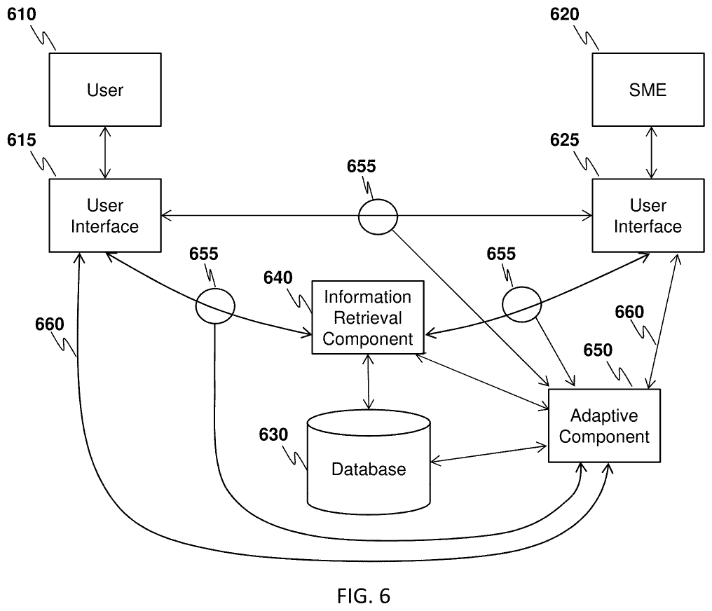

FIG. 6 illustrates a computerized question and answer system according to embodiments of the present invention. The system includes at least an information retrieval component 640 and an adaptive component 650. The system may also include one or more of: user interfaces 615, 625, database 630 and monitoring components 655. Operation of the system components and any associated components will now be described.

For automated information retrieval, a user 610 will enter a query using user interface 615. The user interface is communicatively coupled to the information retrieval component 640 and passes the query to the information retrieval component 640. The information retrieval component may interact with the user 610 via the user interface 615, for example to provide query results, suggestions or interactive dialog. The information retrieval component interacts with the database 630 to search for and retrieve relevant content for answering the user's query. The database stores at least information to be drawn on for answering queries. The information retrieval component can include machine learning or artificial intelligence components, such as NLP components, as described elsewhere herein. In particular, the information retrieval component can retrieve, from the database, potentially relevant content for display as output, based on user input. The output may be indicative at least of potential answers to queries.

For SME-assisted information retrieval, the user 610 can additionally or alternatively interact with the SME 620 via the user interface 615 and a corresponding user interface 625 for the SME 620. This interaction can include discussion regarding the user's question, SME modification and feedback on the user's query, etc.. The SME can interact with the information retrieval component 640 to assist in the query, where the information retrieval component 640 again interacts with the database 630 to return query results.

The adaptive component 650 operates to adjust the system, for example by adjusting operating parameters of the information retrieval component 640, adjusting database 630 records, or both. Adjusting operating parameters of the information retrieval component can include adjusting machine learning or artificial intelligence components, for example by providing training data or adjusting other parameters directly or indirectly. Adjusting database records can include adding new database records, adjusting fields of database records, or adding or adjusting associations between database records.

The adaptive component 650 can perform such adjustments based at least in part on explicit feedback 660 from the user 610, SME 620 or both. The adaptive component 650 can additionally or alternatively perform such adjustments based at least in part on implicit feedback. For this purpose, the adaptive component can monitor operation of the information retrieval component 640 and/or the database 630 and perform adjustments based on information obtained via such monitoring. Additionally or alternatively, the adaptive component can obtain information from one or more monitoring components 655 and perform adjustments based on such information. The monitoring components can monitor interaction between the user 610 and SME 620 (via user interfaces 615, 625), and/or interaction between the user 610 and the information retrieval component 640 (via user interface 615), and/or interaction between the SME 620 and the information retrieval component 640 (via user interface 625). Data obtained by the monitoring components is passed to the adaptive component. For example, user interaction with query responses or user-to-SME interaction can be interpreted as implicit feedback, as described elsewhere herein, and the adaptive component can adjust system operation (e.g. information retrieval component operation) or database content based on same. The adaptive component can be responsible for monitoring, via monitoring components, user-generated input and/or SME-generated input and adding database entries based on such user-generated or SME-generated input. Notably, operation of the adaptive component can be performed concurrently with information retrieval, and can further be based on data generated during such information retrieval.

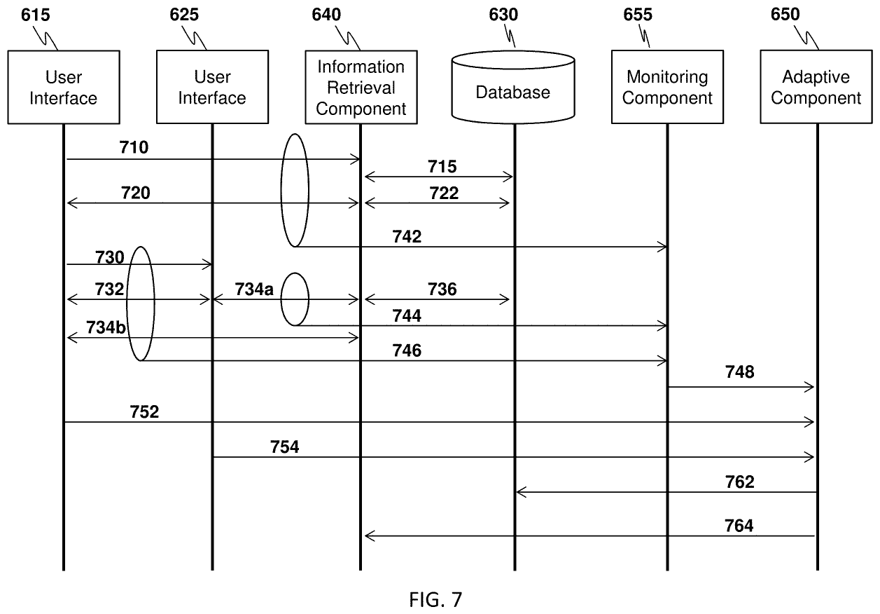

FIG. 7 illustrates interactions between the components of FIG. 6, according to embodiments of the present invention. Some of the interactions may be changed or omitted in various embodiments without necessarily departing from the scope of the invention. As illustrated in FIG. 7, a user may submit a query 710 via user interface 615 to the information retrieval component 640. The information retrieval component may interact 715 with the database 630 to obtain query results, which may be passed back to the user interface 615 in communication 720. Optionally, the communication 720, along with communication 722, may include further interaction between the user interface 615, information retrieval component 640 and database 630, in order to implement an interactive, multi-stage query. The multi-stage query can include presenting and refining query results, using natural language processing.

Queries may additionally involve a SME interacting via a second user interface 625. The user may submit 730 a query to the SME, triggering an interaction 732 between the user interfaces 615, 625, an interaction 734a between the user interface 625 and the information retrieval component 640, and an interaction 734b between the user interface 715 and the information retrieval component 640. The information retrieval component 640 interacts 736 with the database 630 where required to support the query, by providing interactive data where necessary. Generally, these interactions between the SME, the user and the information retrieval component are performed in order to obtain information from the database in order to answer the user's query.

A monitoring component 655 monitors 742 interactions between the user interface 615 and the information retrieval component 640. The monitoring component further monitors 744 interactions between the user interface 625 and the information retrieval component. The monitoring component further monitors 746 interactions between the two user interfaces 615, 625. Results of this monitoring are provided 748 by the monitoring component 655 to the adaptive component 650. Accordingly, implicit feedback may be collected by monitoring user interactions with the system and with one another. Additionally, explicit user feedback 752, 754 can be captured by and provided from the user interfaces 615, 625 to the adaptive component 650.

Based on the implicit and/or explicit feedback, the adaptive component 650 can adjust 762 operating parameters of the information retrieval component 640. For example, training data can be provided to, or other adjustments can be made, to machine learning or artificial intelligence portions of the information retrieval component. Additionally or alternatively, based on the implicit and/or explicit feedback, the adaptive component 650 can adjust 764 one or more records stored in the database 630. For example, records of the user-to-user or user-to-system interactions, or other feedback, can be stored in the database.

In some embodiments, interactions with the system by a user or SME can be recorded in the database and associated with that user or SME. This can be done for some or all users and/or SMEs. Queries can be run on the database designating a user and/or SME, based on the data collected in accordance with such interactions. In some embodiments, for example, a query can be run on a user or SME to determine their level of expertise or familiarity with a given topic, based on the quantity of interactions associated with that topic, the quality of those interactions, or a combination thereof. Thus, the adaptive component not only accumulates subject-matter knowledge, but also knowledge regarding personnel who interact with the system. For example, a user may pose a question and an SME may provide input relevant to an answer to the question. The user's question and the SME's answer can be added as associated entries in the database. As another example, the user and the SME may enter a discussion based on the user's question. The text of the discussion can be added as associated entries in the database. Later queries can return the answer or discussion text when responding to similar questions. The text and discussion can be used as training data for machine learning or artificial intelligence system components.

Embodiments of the present invention can be used as a knowledge tool in industries such as but not necessarily limited to the oil and gas sector. The knowledge tool may be particularly applicable in niche areas where specialist knowledge is required. In the oil and gas industry this can include knowledge regarding activities such as but not necessarily limited to drilling, completions, well testing, interventions and geological operations. Knowledge may further relate to quality plans, procedures and work instructions, as well as oversight of suppliers, equipment and personnel. Embodiments of the present invention can provide a tool to facilitate access to information necessary to perform a task in a timely and efficient manner, as well as access to subject matter experts for advice and validating decisions.

Embodiments of the present invention capture and record input from subject matter experts in order to preserve this information. This is particularly important in industries where loss of a long-term subject matter expert may result in a potentially large loss of information held substantially only or most reliably by the expert. Capturing the information is performed by having the subject matter experts answer questions or assist in answering questions as they arise, and capturing and processing their input. As such, recording an expert's knowledge can occur simultaneously with other actions such as mentorship, which results in a more efficient use of their time. Additionally, smaller and less experienced teams are provided with access to subject matter experts as well as the corresponding automated tool which they can use to plan and execute potentially complex projects with less potential for problems or undesired outcomes. The lessons learned by experts over time can be captured and subjected to complex computer processes which at least partially replace the subject-matter expert's knowledge with an automated expert system. As such, a subject-matter may essentially train, through their response to user queries, the automated question and answer system.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

The system may comprise one or more computing devices, networked together. The computing devices may include personal computers, servers, PDAs or other mobile devices, and the like. The system is implemented using one or more computer processors operatively coupled to memory and configured to execute program instructions stored in memory. Different computers may be linked together via network interfaces. The system may include one or more user interfaces such as video displays, keyboards, mice, audio input and output devices, and the like.

Acts associated with the method described herein can be implemented at least in part using coded instructions in a computer program product. In other words, the computer program product is a computer-readable medium upon which software code is recorded to execute the method when the computer program product is loaded into memory and executed on the microprocessor of the wireless communication device. The computer (e.g. a controller) can direct or drive devices such as a modulator as described herein.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose. The method or system can be implemented using multiple networked computing devices.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

What is claimed is:

1. A computerized question and answer system, comprising:
an information retrieval component configured to automatically retrieve, from a database, potentially relevant content for display as output, based on user input including a user's question, the output indicative of potential answers to the user's question, the database configured to store information to be drawn on for answering the user's question; and
an adaptive component configured to: receive explicit or implicit feedback from the user, said feedback indicative of quality of one or more of the potential answers; and adjust one or more operating parameters of the information retrieval component, one or more records stored in the database, or both, based on said feedback.

2. The system of claim 1, wherein the information retrieval component comprises one or more machine learning or artificial intelligence systems configured to automatically suggest answers or to automatically provide information usable in searching or obtaining answers, and wherein the adaptive component is configured to adjust at least one of the one or more machine learning or artificial intelligence components based on said feedback.

3. The system of claim 2, wherein the one or more machine learning or artificial intelligence components comprises a natural language processing system.

4. The system of claim 2, wherein adjusting at least one of the one or more machine learning or artificial intelligence components comprises providing said feedback as training data to the at least one of the one or more machine learning or artificial intelligence components.

5. The system of claim 1, wherein the adaptive component is configured to store, in the database, said user feedback, or wherein the adaptive component is configured to process said user feedback and store, in the database, output of processing of said user feedback.

6. The system of claim 1, wherein the information retrieval component is configured to provide previous questions which are stored in the database and deemed potentially similar to the user's question, and previous answers to the previous questions, said providing performed automatically based on one or both of: the user's question; and a subject-matter expert's response to the user's question.

7. The system of claim 6, wherein the adaptive component is configured to store, in the database, the user's question along with said feedback, or along with an indication, based on said feedback, of user-influenced similarity between the user's question and one or more of the previous questions.

8. The system of claim 1, wherein the adaptive component is further configured to adjust one or more operating parameters of the information retrieval component, one or more records stored in the database, or both, based on additional explicit or implicit feedback obtained from a subject matter expert, said additional feedback indicative of quality of one or more of the potential answers, said additional feedback obtained after the subject matter expert interacts with the user's question.

9. The system of claim 8, wherein the adaptive component is further configured to adjust one or more operating parameters of the information retrieval component, one or more records stored in the database, or both, based on input from the subject-matter expert indicative of potential answers to the user's question or indicative of suggestions for adjusting the user's question.

10. The system of claim 1, wherein the feedback from the user comprises one or more aspects of the user's interaction with the output.

11. The system of claim 1, further comprising a visual interface having a plurality of synchronized components to show abstract and detailed views of the output.

12. The system of claim 11, wherein the visual interface includes a relevance map.

13. The system of claim 11, wherein the visual interface includes a word cloud in which the size and color of each word is based on its frequency of occurrence.

14. The system of claim 11, wherein the visual interface includes an interactive Sankey graph that connects and ranks questions and answers, and serves to collect user feedback.

15. The system of claim 11, wherein the visual interface includes a ranking chart.

16. The system of claim 1, wherein the adaptive system is configured to store, in the database, questions and answers generated during usage of the system.

17. The system of claim 1, wherein said implicit feedback comprises a degree to which the user interacts with the potential answers.

18. A computerized question and answer method, comprising:
automatically retrieving, from a database, potentially relevant content for display as output, the retrieving based on user input including a user's question, the output indicative of potential answers to the user's question, the database configured to store information to be drawn on for answering the user's question;
receiving explicit or implicit feedback from the user, said feedback indicative of quality of one or more of the potential answers; and
adjusting one or more operating parameters of the information retrieval component, one or more records stored in the database, or both, based on said feedback.

19. The method of claim 18, further comprising:
by one or more machine learning or artificial intelligence systems, automatically suggesting answers or automatically providing information usable in searching or obtaining answers; and
adjusting at least one of the one or more machine learning or artificial intelligence systems based on said feedback.

20. The method of claim 18, further comprising receiving input from a subject matter expert, and wherein said adjusting one or more operating parameters of the information retrieval component, one or more records stored in the database, is performed based on interaction between the user and the subject matter expert.
